(19) United States
(12) Patent Application Publication
(10) Pub. No.: US 2026/0191137 A1
(43) Pub. Date: Jul. 9, 2026

(54) GEOGRAPHICALLY AUGMENTED CROP LOSS SENSING

(71) Applicant: Deere & Company, Moline, IL (US)

(72) Inventors: Eric L. BORTNER, Davenport, IA (US); Regent W. ERICKSON, East Moline, IL (US)

(21) Appl. No.: 19/012,230

(22) Filed: Jan. 7, 2025

(51) Int. Cl. A01D 41/127; H04W 4/029

(52) U.S. Cl. CPC A01D 41/1273; H04W 4/029

(57) ABSTRACT

A crop loss correction system receives one or more crop loss sensor signals that are indicative of crop lost by a harvesting machine. A correction component receives geographic context information from a set of geographic context sensing components to identify a geographic context of the harvesting machine. The correction component corrects the crop loss sensor signals, based upon the geographic context information, to obtain a corrected loss signal indicative of the sensed crop loss, corrected based on the mobile machine context. The corrected loss signal is output to an output device.

### FILED OF THE DESCRIPTION

The present description relates to agricultural sensing. More specifically, the present description relates to using geographic information to augment crop loss sensing in a harvesting machine.

### BACKGROUND

There are a wide variety of different types of harvesting machines that harvest crops. Some such machines include sensors that attempt to sense crop loss.

The crop loss sensors generate a sensor signal that is indicative of an amount of crop that is lost during the harvesting operation. For instance, some current agricultural operations use combines to harvest grain. It is common for combines to include loss sensors that sense some type of metric that can be indicative of the amount of the harvested crop being lost during the harvesting operation. The loss sensors can include a set of sensors that monitor grain loss from various parts of the combine. The sensors can include, for instance, a set of shoe loss sensors that sense grain loss from the cleaning shoe. The sensors can also include a set of separator loss sensors that sense loss from the separator. There are a variety of different kinds of sensors. Such sensors can include, for instance, strike sensors that count grain strikes per unit of time (or per unit of distance travelled) to provide an indication of the amount of grain lost.

The discussion above is merely provided for general background information and is not intended to be used as an aid in determining the scope of the claimed subject matter.

### SUMMARY

A crop loss correction system receives one or more crop loss sensor signals that are indicative of crop lost by a harvesting machine. A correction component receives geographic context information from a set of geographic context sensing components to identify a geographic context of the harvesting machine. The correction component corrects the crop loss sensor signals, based upon the geographic context information, to obtain a corrected loss signal indicative of the sensed crop loss, corrected based on the mobile machine context. The corrected loss signal is output to an output device.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one example of a crop loss correction architecture.

FIG. 2 is a pictorial illustration of one example of a portion of the architecture shown in FIG. 1, deployed on a combine.

FIG. 3 is a flow diagram illustrating one example of generating a knowledge base that is used to correct crop loss sensor signals.

FIG. 4 is a flow diagram illustrating one example of the operation of the architecture shown in FIG. 1 in generating and outputting a corrected loss value.

FIG. 5 is a block diagram of one example of a correction component FIG. 6 is a flow diagram illustrating one example of the operation of the grain loss correction system.

FIG. 7 is a flow diagram illustrating one example of the operation of a loss output system.

FIG. 8 is a block diagram of one example of a remote server environment.

FIGS. 9-11 show examples of mobile devices that can be used in the architectures shown in the previous figures.

FIG. 12 is a block diagram of one example of a computing environment that can be deployed in any of the architectures shown in previous figures.

### DETAILED DESCRIPTION

For the purposes of promoting an understanding of the principles of the present disclosure, reference will now be made to the examples illustrated in the drawings, and specific language will be used to describe the same. It will nevertheless be understood that no limitation of the scope of the disclosure is intended. Any alterations and further modifications to the described devices, systems, methods, and any further application of the principles of the present disclosure are fully contemplated as would normally occur to one skilled in the art to which the disclosure relates. In particular, it is fully contemplated that the features, components, and/or steps described with respect to one example may be combined with the features, components, and/or steps described with respect to other examples of the present disclosure.

As discussed above, many harvesters have loss sensors that sense loss of harvested material during the harvesting operation. For instance, where the harvester is a grain harvester, the loss be prone to inaccuracy. Also, the accuracy of the sensors may depend on a wide variety of different context information that indicates the context of the harvester.

The present description thus describes a system that senses a variety of different context characteristics corresponding to a harvester or the material being harvested or other context characteristics and uses the context characteristics to, for instance, generate a corrected loss signal or a corrected loss value based on a loss sensor signal generated by a loss sensor. The present description proceeds with respect to a system that can perform sensor fusion to combine the outputs of multiple different context sensors to generate a sensor fusion correction output. Similarly, the present description describes a system which can identify geographic context information and/or historical context information and generate a geographic or historic correction output. Further, the present description describes a system that can detect different pressures as context information. The pressures can include barometric pressure or the body pressure inside the harvester body to generate a pressure correction output. Based upon the geographic and/or historic correction output, the sensor fusion correction output, and/or the pressure correction output, the present system may select a particular loss correction system that can be used to correct a loss signal or loss value generated by strike sensors that sense grain strikes in material being transferred out of the harvester.

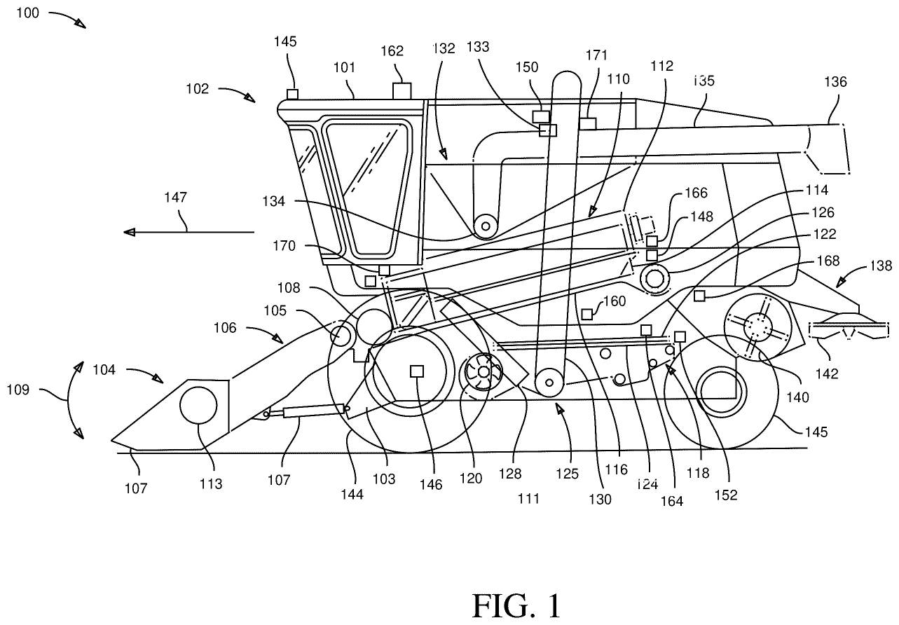

FIG. 1 is a partial pictorial, partial schematic illustration of agricultural harvester 100. Harvester 100 includes a body portion 102 and a header portion (or header) 104, coupled to the body portion 102. Harvester 100 includes an operator compartment 101, a feeder house 106, a feed accelerator 108, and a thresher generally indicated at 110. The feeder house 106 and the feed accelerator 108 form part of a material handling subsystem 125. Header 104 is pivotally coupled to a frame 103 of non-header portion 102 along pivot axis 105. One or more actuators 107 drive movement of header 104 about axis 105 in the direction generally indicated by arrow 109. Thus, a vertical position of header 104 (the header height) above ground 111 over which the header 104 travels is controllable by actuating actuator 107. While not shown in FIG. 1, agricultural harvester 100 may also include one or more actuators that operate to apply a tilt angle, a roll angle, or both to the header 104 or portions of header 104.

Thresher 110 illustratively includes a threshing rotor 112 and a set of concaves 114. Further, agricultural harvester 100 also includes a separator 116. Agricultural harvester 100 also includes a cleaning subsystem or cleaning shoe (collectively referred to as cleaning subsystem 118) that includes a cleaning fan 120, chaffer 122, and sieve 124. The material handling subsystem 125 also includes discharge beater 126, tailings elevator 128, and clean grain elevator 130. The clean grain elevator moves clean grain into clean grain tank 132.

Harvester 100 also includes a material transfer subsystem that includes a conveying mechanism 134, a chute 135, and a spout 136. Conveying mechanism 134 can be a variety of different types of conveying mechanisms, such as an auger or blower. Conveying mechanism 134 is in communication with clean grain tank 132 and is driven (e.g., hydraulicly, mechanically, electrically, etc.) to convey material from grain tank 132 through chute 135 and spout 136. Chute 135 is rotatable through a range of positions (shown in the storage position in FIG. 1) away from agricultural harvester 100 to align spout 136 relative to a material receptacle (e.g., grain cart, towed trailer, etc.) that is configured to receive the material. Spout 136, in some examples, is also rotatable to adjust the direction of the crop stream exiting spout 136.

Harvester 100 also includes a residue subsystem 138 that can include chopper 140 and spreader 142. Harvester 100 also includes a propulsion subsystem that includes an engine that drives ground engaging traction components, such as 144 or 144 and 145 to propel the harvester 100 across a worksite such as a field (e.g., ground 111). In some examples, a harvester within the scope of the present disclosure may have more than one of any of the subsystems mentioned above. In some examples, harvester 100 may have left and right cleaning subsystems, separators, etc., which are not shown in FIG. 1.

In operation, and by way of overview, harvester 100 illustratively moves through a field in the direction indicated by arrow 147. As harvester 100 moves, header 104 engages crop plants to be harvested and separates the crop material (e.g., the ear or the head) from the plants.

The separated crop material is engaged by a cross auger 113 which conveys the separated crop material to a center of the header 104 where the severed crop material is then moved through a conveyor in feeder house 106 toward feed accelerator 108, which accelerates the separated crop material into thresher 110. The separated crop material is threshed by rotor 112 rotating the crop against concaves 114. The threshed crop material is moved by a separator rotor in separator 116 where a portion of the residue is moved by discharge beater 126 toward the residue subsystem 138. The portion of residue transferred to the residue subsystem 138 is chopped by residue chopper 140 and spread on the field by spreader 142. In other configurations, the residue is released from the agricultural harvester 100 in a windrow.

Grain falls to cleaning subsystem 118. Chaffer 122 separates some larger pieces of material from the grain, and sieve 124 separates some of finer pieces of material from the clean grain. Clean grain falls to an auger that moves the grain to an inlet end of clean grain elevator 130, and the clean grain elevator 130 moves the clean grain upwards, depositing the clean grain in clean grain tank 132. Residue is removed from the cleaning subsystem 118 by airflow generated by cleaning fan 120. Cleaning fan 120 directs air along an airflow path upwardly through the sieves and chaffers. The airflow carries residue rearwardly in harvester 100 toward the residue handling subsystem 138.

Tailings elevator 128 returns tailings to thresher 110 where the tailings are re-threshed. Alternatively, the tailings also may be passed to a separate re-threshing mechanism by a tailings elevator or another transport device where the tailings are re-threshed as well.

Harvester 100 can include a variety of sensors, some of which are illustrated in FIG. 1, such as location sensor 145, ground speed sensor 146, one or more separator loss sensors 148, a clean grain camera 150, and one or more loss sensors 152 provided in the cleaning subsystem 118, body pressure sensor 160, barometric pressure sensor 162, chaff volume sensor 164, material other than grain (MOG) volume sensor 166, a crop property sensor, such as MOG moisture sensor 168, crop moisture sensor 170, etc.

Location sensor 145 can be a global navigation satellite system (GNSS) receiver, a cellular triangulation system, a dead reckoning system, or another type of sensor that provides the location of harvester 100 in a global or local coordinate system.

Ground speed sensor 146 senses the travel speed of harvester 100 over the ground 111. Ground speed sensor 146 may sense the travel speed of the harvester 100 by sensing the speed of rotation of the ground engaging traction components (such as wheels or tracks), a drive shaft, an axle, or other components. In some instances, the travel speed may be sensed using the input from other sensors such as position sensor 145, or sensor 146 may be a Doppler speed sensor, or a wide variety of other systems or sensors that provide an indication of travel speed. Ground speed sensors 146 can also include direction sensors such as a compass, a magnetometer, a gravimetric sensor, a gyroscope, GPS derivation, to determine the direction of travel in two or three dimensions in combination with the speed. This way, when harvester 100 is on a slope, the orientation of harvester 100 relative to the slope is known. For example, an orientation of harvester 100 could include ascending, descending or transversely travelling the slope (e.g., tilted to one side or another).

Separator loss sensor 148 provides a signal indicative of grain loss in the left and right separators, not separately shown in FIG. 1. The separator loss sensors 148 may be associated with the left and right separators and may be strike sensors which count grain strikes per unit of time or per unit of distance traveled to provide an indication of the grain loss occurring at the separator 110. Sensors 148 may provide separate grain loss signals or a combined or aggregate signal. In some instances, sensing grain loss in the separators may also be performed using a wide variety of different types of sensors as well.

Loss sensors 152 illustratively provide an output signal indicative of the quantity of grain loss occurring in both the right and left sides of the cleaning subsystem 118. In some examples, sensors 152 are strike sensors which count grain strikes per unit of time or per unit of distance traveled to provide an indication of the grain loss occurring at the cleaning subsystem 118. The strike sensors for the right and left sides of the cleaning subsystem 118 may provide individual signals or a combined or aggregated signal. In some examples, sensors 152 may include a single sensor as opposed to separate sensors provided for each cleaning subsystem 118.

Clean grain camera 150 illustratively observes the grain that is being conveyed into or has been conveyed into clean grain tank 132. Clean grain camera 150 may detect various characteristics, such as the cleanliness of the grain within or being conveyed to clean grain tank 132. For example, clean grain camera 150 may detect an amount of MOG comingled with the grain within or being provide to clean grain tank 132.

Body pressure sensor 160 senses the pressure in the body of harvester 100. Cleaning fan 120 may cooperate with a set of vents to increase or decrease the pressure inside the body of harvester 100. As the fan speed increases and/or the vents are closed, the pressure in the body of harvester 100 increases. As the fan speed decreases and/or the vents are opened, the pressure decreases. Sensor 160 may be a diaphragm sensor or another sensor.

Barometric sensor 162 senses the atmospheric pressure in the environment of harvester 100.

Chaff volume sensor 164 senses the volume of chaff being processed by harvester 100 and generates an output signal indicative of the sensed volume. For instance, chaff volume sensor 164 may sense the volume of material on the cleaning shoe 118. That volume is indicative of the amount of chaff in the system. Thus, chaff volume sensor 164 may be an optical sensor that captures an image of the chaff on cleaning shoe 118 and processes that image to generate a volume output indicative of the volume of the chaff. Chaff volume sensor 164 may be another type of contact sensor or noncontact sensor as well.

MOG volume sensor 166 senses the volume of MOG being processed by harvester 100 and generates an output indicative of that volume. Thus, MOG volume sensor 166 may sense the amount of material on separator 110. MOG volume sensor 166 may thus be an optical sensor, or another type of sensor that senses the volume of MOG on separator 110.

Harvester 100 may include other sensors that sense characteristics of the harvested crop. Such characteristics can be moisture or other characteristics. For instance, MOG moisture sensor 168 may be a capacitive sensor or another sensor that senses the moisture content of the MOG in harvester 100. Harvested material moisture sensor 170 may also be a capacitive sensor or another type of sensor that senses the moisture of the kernels being harvested by harvester 100.

The sensors can include a wide variety of other sensors as well. For instance, a kernel weight sensor 171 can be used to accumulate a number of kernels to obtain a kernel weight metric (such as a thousand kernel weight value) which is indicative of the weight of a given number of kernels (e.g., a thousand kernels). A capture chamber can be used to divert kernels from the clean grain traveling through elevator 130. An optical sensor or other sensor can be used to count the number of kernels captured and a scale or other measurement mechanism can be used to measure the weight of the captured kernels. Other ways of obtaining a kernel weight value are contemplated herein as well. Further, the sensors can include a mass flow rate sensor which may sense the mass flow of material through harvester 100. Such a sensor may sense the rotor pressure of rotor 112, or the mass of material flowing through clean grain elevator 130, or elsewhere. These and other sensors are contemplated herein. Further, a grain flow sensor or yield sensor 133 can be located anywhere to sense the mass flow of grain or yield of grain or other harvested crop. Sensor 133 can sense clean grain flowing through the harvester per unit of time. Sensor 133 can be a force-based system, a volume-based system, a torque-based system, an image capture and image processing system, a fusion system that uses the output of sensor 171 and a kernel size sensor to generate a volume, as examples.

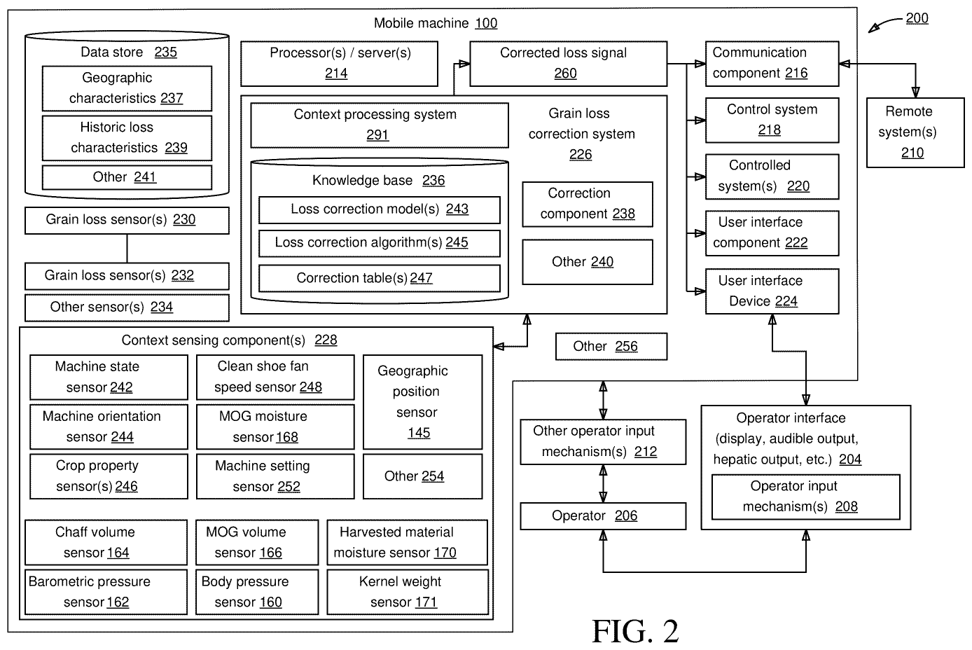

FIG. 2 is a block diagram of one example of a crop loss correction architecture 200. Architecture 200 shows mobile machine 102 generating operator interfaces 204 for interaction by user (or operator 206). Operator interfaces 204 can include user interface displays, audible outputs, haptic outputs, etc. Operator interfaces 204 can also include a set of operator input mechanisms 208. Operator 206 illustratively interacts with operator input mechanisms 208 in order to control and manipulate various portions of mobile machine 100. Architecture 200 also shows that mobile machine 100 can be connected to various remote systems 210. Operator 206 can also use other user input mechanisms 212 to interact with mobile machine 100.

Operator input mechanisms 208 can be displayed on operator interface displays 204. Therefore, the displays can be touch sensitive display elements, icons, links, etc. Other operator input mechanisms 208 can be a whole host of user input mechanisms that can be used to control machine 100. These can include such things as switches, levers, push buttons, keypads, pedals, steering wheels, joysticks, etc.

In the example described herein, some or all the components shown in mobile machine 100 may be on the external machine, on a remote system (e.g., in the cloud), or distributed among different systems at different locations. Also, it will be noted that the present discussion will proceed with respect to mobile machine 100 harvesting grain, but machine 100 could be harvesting other crops as well.

In the example shown in FIG. 2, mobile machine 100 illustratively (and by way of example only) includes one or more processors or servers 214, communication component 216, control system 218, controlled systems 220, user interface component 222, and user interface device 224. Machine 100 also illustratively includes grain loss correction system 226, context sensing components 228, one or more grain loss sensors 230-232, and a variety of other sensors 234. Machine 100 can include data store 235 which stores geographic characteristics 237, historic loss characteristics 239, and other items 241.

Grain loss correction system 226, itself, illustratively includes knowledge base 236 (which can include one or more loss correction models 243, one or more loss correction algorithms 245, one or more correction tables 247, and/or other items), correction component 238, context processing system 291, and can include other items 240.

Controlled systems 220 can include, for instance, electrical systems, mechanical systems, hydraulic systems, pneumatic systems, air-over-hydraulic systems, or other systems. These systems can perform harvesting functions, be controlled by settings values, be controllable subsystems, and/or be a wide variety of other functions on mobile machine 100.

Context sensing components 228 can include a variety of sensors that sense information about machine 100, crop characteristics, environmental characteristics, or other information that affects the accuracy of grain loss sensors 230-232 in sensing actual grain loss. Components 228 can thus include sensors such as machine state sensor 242, machine orientation sensor 244, geographic position sensor 145, crop property sensor 246, cleaning shoe fan speed sensor 248, material other than grain (MOG) moisture sensor 168, machine setting sensor 152, chaff volume sensor 164, MOG volume sensor 166, barometric pressure sensor 162, body pressure sensor 160, harvested material moisture sensor 170, kernel weight sensor 171, and it can include other items or sensors 254. Mobile machine 100 can include other items 256, as well.

Before describing the operation of architecture 200 in more detail, a brief overview of some of the items in architecture 200, and their operation, will first be provided. Where mobile machine 100 is a combine harvester, grain loss sensors 230-232 can include one or more shoe loss sensors 152 deployed to sense grain loss at the cleaning shoe 118. Grain loss sensors 230-232 can also include one or more separator loss sensors 148 that are deployed to sense grain loss at separator 110. The grain loss sensors 230-232 can include a variety of other grain loss sensors as well.

Grain loss correction system 226 illustratively receives the grain loss sensor signals from sensors 230-232. It will be noted that the grain loss sensor signals sometimes do not reflect the actual grain loss. Therefore, grain loss correction system 226 corrects the grain loss and provides a corrected loss signal 260. The corrected loss signal illustratively reflects the actual grain loss more accurately than the grain loss sensor signals from grain loss sensors 230-232.

In generating the corrected loss signal 260, grain loss correction system 226 illustratively receives context information from context sensing components 228 which indicates the context of mobile machine 100, the context of the crop, the context of the environment, etc. As will be described in greater detail below, the context information can include a wide variety of different information that may bear on, affect, or be correlated to, the accuracy of the signals received from grain loss sensors 230-232 in sensing actual grain loss. Knowledge base 236 illustratively includes corrective components (e.g., models 243, algorithms 245, tables 247, etc.), that can be generated, configured, and/or trained by context processing system 291. The corrective components can be used to correct the sensor signals received from sensors 230-232, to generate corrected loss signal 260, based upon the context of mobile machine 100. Therefore, correction component 238 illustratively receives the context information and accesses knowledge base 236 to make corrections to the sensor signals from sensors 230-232, and to thus generate corrected loss signal 260, which more closely reflects the actual grain loss. In one example

Signal 260 can then be provided to a wide variety of different components. For instance, signal 260 can be provided to communication component 216 which communicates the signal to remote systems 210. Signal 260 can be provided to control system 218 which automatically generates control signals to control the various controlled systems 220 on mobile machine 100, based upon corrected grain loss signal 260. Signal 260 can be provided to operator interface component 222 which controls operator interface device 224 to display the corrected grain loss signal, through some visual, audible, haptic, or other indicia, to operator 206.

Machine setting sensor 252 can include one or more sensors that are configured to sense the various configurable settings on machine 100. Machine orientation sensor 244 can include a wide variety of different types of sensors that can sense the orientation of machine 100. Machine orientation sensor 244 can include a GNSS receiver, inertial measurement unit(s), accelerometer(s), etc. Crop property sensors 246 can be one or more sensors that are configured to sense a wide variety of different types of crop properties, such as crop type, kernel hardness or brittleness, and other crop properties. Crop property sensor 246 may also be configured to sense crop characteristics as the crop is processed by machine 100. For instance, crop property sensor 246 can include a grain feed rate sensor. In one example, sensor 246 is deployed in elevator 130 and senses mass flow through elevator 130 and that provides an output signal indicative of the mass flow rate. The mass flow rate may be used to represent mass flow and yield in bushels per hour, tons per hectare, tons per hour, or in other units. Other sensors have been described elsewhere herein.

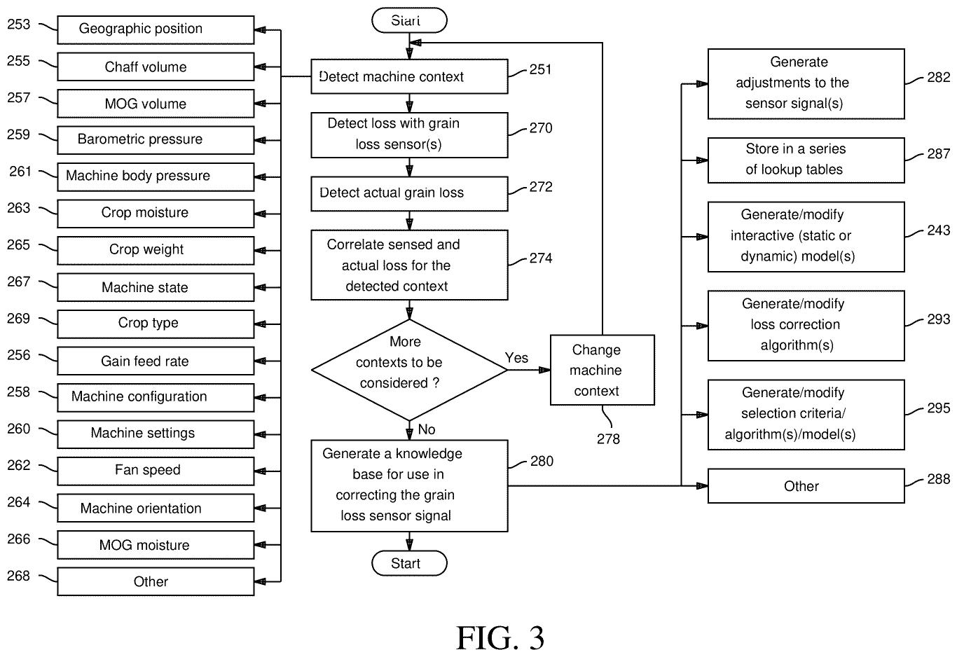

Before describing the overall operation of machine 100, a description of how grain loss correction system 226 and data store 235 are configured to generate corrected loss signal 260 will first be provided. FIG. 3 is a flow diagram illustrating one example of the operation of machine 100 and context processing system 291 to generate knowledge base 236 in grain loss correction system 226 and to obtain values in data store 235. In one example, the values or corrective components in knowledge base 236 and/or data store 235 are obtained without performing the operation in FIG. 3, such as by downloading the values and/or corrective components or otherwise obtaining the values. In another example, the operation shown in FIG. 3 is performed to obtain values and/or corrective components for knowledge base 236 and/or data store 235 and need not be repeated. Those values can be loaded onto other similar machines as well.

To generate values in data store 235 and knowledge base 236, machine 100 can first be configured so that machine 100 can sense actual grain loss. For instance, in one example, machine 100 can be fitted with an attachment or towed mechanism that collects all the material coming out of machine 100. That material can then be weighed or otherwise analyzed to obtain a measure of actual grain loss, with a relatively high degree of accuracy. Then, machine 100 can be operated in different contexts to identify how the grain loss sensed by the grain loss sensors 148, 152 (230-232) differs from the actual grain loss, in those different contexts. There are many other ways to detect actual grain lost as well, other than using an attachment or towed mechanism, and these are examples only. This information can then be used by context processing system 291 to generate corrective components in knowledge base 236, that can be used by correction component 238 to correct the grain loss sensor signals, based upon a current context in which machine 100 is operating, to obtain the corrected loss signal 260.

Similarly, geographic characteristics 237 that describe the terrain over which machine 100 is traveling as the actual loss is measured can be sensed and recorded. Those geographic characteristics can include a wide variety of characteristics, such as the slope and tilt of the terrain, the elevation of the terrain, the traction corresponding to the terrain (e.g., whether wheel slip is occurring), the moisture of the terrain (e.g., whether the train is muddy), and/or any of a wide variety of other geographic characteristics.

Further, as a harvesting operation is being performed, the loss characteristics can be sensed and recorded for use during a subsequent harvesting operation. Thus, the loss characteristics, referred to as historical loss characteristics 239, indicate various characteristics of the crop loss sensed during a prior harvesting operation. By way of example, the historical loss characteristics 239 may be the historical, measured grain loss in a field, at certain points in the field, correlated to the geographic location of machine 100 in the field, correlated to different environmental characteristics, and/or correlated to different terrain characteristics, crop characteristics, machine characteristics, or other characteristics.

FIG. 3 thus shows that the machine context is first detected, as indicated by block 251. In one example, the various different contexts that are detected are those which will most affect the accuracy of the grain loss sensed by grain loss sensors 230-232 (e.g., separator loss sensors 148 and shoe loss sensors 152). A number of examples of different contexts that will affect the accuracy of the sensed grain loss will now be discussed. It will be appreciated, however, that these are examples only.

Geographic position 253 of mobile machine 100 may affect the accuracy of the grain loss sensors 230-232. For instance, grain loss sensors 230-232 may be more or less accurate at different elevations, in different hemispheres, in different regions of a country (such as where the humidity in the different regions varies), or based on other geographic characteristics. The accuracy of the loss sensors 230-232 may also be affected by the chaff volume 255 sensed by chaff volume sensor 164 and/or the MOG volume 257 sensed by MOG volume sensor 166. The accuracy of the loss sensors 230-232 can be affected based on barometric pressure 259 sensed by sensor 162, machine body pressure 261 sensed by sensor 160, as well as crop characteristics, such as crop moisture 263 sensed by sensor 170. The accuracy of the loss sensors 230-232 can also be affected by the weight of the crop material (e.g., by the thousand kernel weight) 265 sensed by sensor 171.

The state of machine 100, with respect to whether it is configured to chop the residue or drop a windrow behind the machine 100 and spread it, may affect the accuracy of the sensor signals from the grain loss sensors. That is, the ability to accurately sense grain loss using the grain loss sensors 230-232 may change based upon whether the machine state is set for chopping or dropping a windrow. Thus, machine state sensor 242 can sense machine state 267.

Crop property sensor 246 can also sense a variety of different properties of the crop being harvested. An example of a property is the crop type 269. The ability to accurately sense grain loss may vary with crop type (e.g., corn, soybeans, wheat, barley, canola, etc.). Thus, the 29 type of crop can be sensed or provided by the operator and used as context information.

Grain feed rate 256 may also provide contextual information indicative of grain loss sensing performance. Thus, sensors 246 can include a mass flow sensor that senses grain feed rate in elevator 130, or another type of sensor that senses grain feed rate.

Further, machine 100 can have different configurations, and the machine configuration 258 may affect the ability to accurately sense grain loss. For instance, machine 100 may be configured with different separator mechanisms 110, and the ability to accurately sense grain loss may differ depending on the mechanism being used. Thus, machine state sensor 242 can also include a sensor that indicates the machine configuration 258.

The various machine settings (which can be configured by the operator or automatically configured) may affect the ability to accurately sense grain loss as well. Thus, machine settings 260 can be sensed by machine settings sensor 252.

In one example, the fan speed 262 of the cleaning shoe fan 120 also affects the ability to accurately sense grain loss. By way of example, if the fan speed is too high, this can cause some of the grain to become airborne with a trajectory that causes the grain to miss the cleaning shoe loss sensors 152. This type of grain loss will thus not be sensed. Therefore, fan speed sensor 248 can provide an indication of fan speed 262.

The orientation 264 of machine 100 sensed by machine orientation sensor 244 may also affect the ability to accurately sense grain loss. For instance, where the machine is exhibiting a roll characteristic (such as where it is harvesting on a side hill), this may result in a non-uniform shoe loss distribution across the width of the machine. The accuracy of the grain loss sensors 230-232 may thus be affected. Therefore, machine orientation sensor 244 can sense machine orientation 264.

The moisture level of the MOG may affect the ability to accurately sense grain loss. By way of example, when the MOG has a relatively high moisture content, it can form a MOG mat as it is moved through machine 100. In that case, the amount of grain that can pass through the mat and be sensed by the sensors 230-232, may be affected. This can be exacerbated where the grain is relatively light, such as where the grain is wheat. Instead of being sensed, the grain is simply carried by the high moisture MOG mat out of the machine 100, and that lost grain is not sensed by any of the sensors 230-232. Thus, MOG moisture sensor 250 can sense MOG moisture 266 and weight sensor 171 can sense crop weight 265 and the combination of contexts can be used to correct loss.

Of course, a wide variety of other context sensors 254 can sense other contextual information 268 as well. Similarly, different combinations of context information can be used to correct sensed loss as well. Some such combinations are described elsewhere herein. All of that information can be used by context processing system 291 to generate knowledge base 236 and/or data store 235.

While the machine context is sensed, the machine is operated, and grain loss is detected with the grain loss sensors 230-232 on the machine, as indicated by block 270. The actual grain loss is also sensed (or otherwise determined, such as by collecting material expelled from the machine 100 and counting loss) as indicated by block 272. Then, the sensed grain loss and actual grain loss for the present machine context are correlated by context processing system 291 to identify any error in the sensed grain loss, relative to the actual grain loss as indicated by block 274.

This process can be repeated for a variety of different contexts so that the relationship between the crop loss sensing error and those different contexts can be identified. Thus, at block 276 it is determined whether additional contexts are to be considered. If so, then the machine context is changed to the next context to be considered, at block 278, and processing returns to block 250.

Once all the different machine contexts have been considered, then context processing system 291 processes the context information, sensed loss, and actual loss to identify correlations that can be used to correct sensed loss to obtain corrected loss. The correlations are then used to generate the corrective components in knowledge base 236. The corrective components in knowledge base 236 are used to correct the grain loss sensor signal, during runtime operation of machine 100. Generating the corrective components in knowledge base 236 is indicated by block 280.

Generating the corrective components can be done in a wide variety of different ways as well. For instance, knowledge base 236 can include a set of adjustment values that are applied to the grain loss sensor signals to adjust the sensor signals, based upon the machine context. Generating adjustment values is indicated by block 282. In that case, during runtime, correction component 238 receives the runtime context information from components 228 and identifies an adjustment value in knowledge base 236 to adjust the grain loss sensor signals to generate the corrected loss signal 260.

In another example, the corrective components in knowledge base 236 can include a series of lookup tables 247. The lookup tables 247 may be used by correction component 238 to walk through a series of lookups and mathematical operations, based upon the context information received from components 228, and based upon the changes in the context information.

In yet another example, the corrective components in knowledge base 236 include one or more static or dynamic interactive models 243. In that example, correction component 238 can call into the interactive model 243, passing in the context information received from components 228, and the sensor signal values received from grain loss sensors 230-232, and the model can return either a correction value, or the corrected loss signal 260. Context processing system 291 can generate one or more models 243 using a wide variety of techniques, such as linear regression, probabilistic model generation, machine learning (including, among others, deep learning, re-enforcement learning, support vector machine learning, etc.), K-nearest neighbor learning, etc.

In another example, context processing system 291 generates or modifies one or more different loss correction algorithms 245 based upon the context information. For instance, the loss correction algorithms may have coefficients or other factors or configurable elements that can be modified during learning. Generating or modifying the loss correction algorithms 245 is indicated by block 293 in the flow diagram of FIG. 3.

Also, in one example, knowledge base 236 includes a selection component (such as selection criteria, a selection algorithm, a selection model, etc) that can be used to select a correction system, such as a system that runs or employs different models 243, algorithms 245, lookup tables 247, or other corrective components that may be used by correction component 238 to correct the loss signal generated by the loss sensors 230-232, during runtime, to obtain corrected loss signal 260. For instance, in certain contexts it may be more accurate to use a probabilistic correction model 243 while in other contexts it may be more accurate to use an artificial neural network correction model 243. Further, in a first context it may be more accurate to use a first correction algorithm 245 while in another context it may be more accurate to use a different correction algorithm 245. Also, in one context it may be more accurate to use a first lookup table 247 while in another context it may be more accurate to use a different lookup table 247. The criteria for selecting a corrective component in knowledge base 236, or a set of corrective components, may also be learned and embodied in a selection algorithm or a selection model that takes, as its input, the sensed context and generates an output indicative of which model 243, algorithm 245, lookup table 247, etc. should be used by correction component 238 in order to generate corrected loss signal 260.

Therefore, in one example, context processing system 291 generates or modifies a set of selection criteria, a selection algorithm, and/or a selection model that is used to use select the corrective component 243, 245, 247 during runtime. Generating or modifying such selection criteria, algorithms, and/or models as indicated by block 295 in the flow diagram of FIG. 3. All of these, and a wide variety of other techniques 288 for generating knowledge base 236 are contemplated herein.

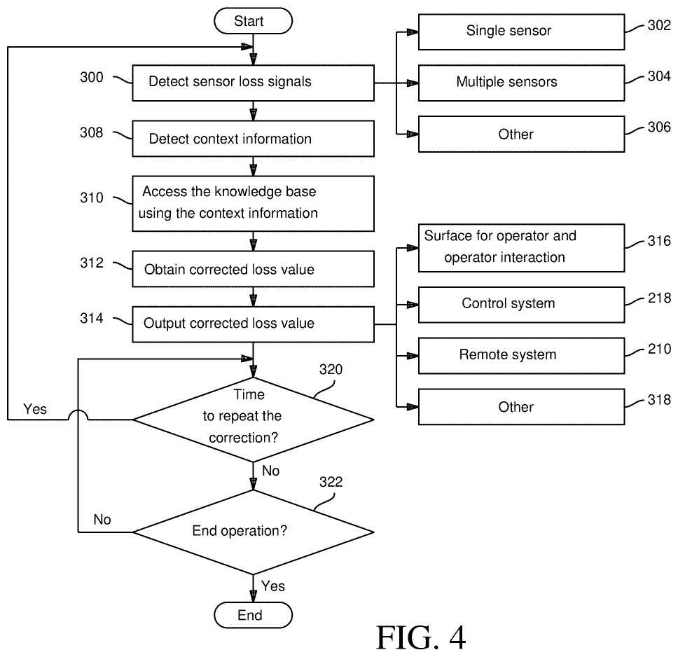

FIG. 4 is a flow diagram illustrating one example of the operation of architecture 200 (shown in FIG. 2) in generating corrected loss signal 260, during the runtime operation of machine 100. It is first assumed that machine 100 is performing a harvesting operation and that the grain loss sensors 230-232 are providing grain loss sensor signals. Thus, grain loss correction system 226 detects the sensor loss signals as indicated by block 300. It will be noted that the grain loss sensors 230-232 can comprise a single sensor 302 (or a single, aggregate signal from multiple sensors), or sensors 230-232 can include multiple sensors 304 that each provide an individual sensor signal. Of course, other combinations of sensors and sensor signals 306 can be used as well.

Correction component 238 detects the machine context information provided by one or more of context sensing components 228, as indicated by block 308. Correction component 238 then accesses one or more corrective components in knowledge base 236 using the context information as indicated by block 310. Correction component 238 can apply the corrective components in knowledge base 236 to obtain corrected loss values that can be applied to the sensor signals, as indicated by block 312.

Correction component 238 then applies those corrective components to generate the corrected loss signal 260, as indicated by block 314. As mentioned above, the corrective components can be adjustment values that are applied to the sensed loss values to correct them. Such adjustment values can be obtained, for example, from look-up tables 247, from a correction model 243, from a correction algorithm 245, etc. The adjustments can be implemented by a series of values and calculations. The adjustment values can be the corrected loss values themselves (such as values received from an interactive correction model), or other values.

The corrected loss signal 260 can be output to a variety of different systems or components, for a variety of different uses. For instance, signal 260 can be surfaced for the operator to inform the operator of the corrected grain loss, and for operator interaction, as indicated by block 316. By way of example, if the corrected grain loss signal 260 is above a desired value, control system 218 may provide options that can be selected by the operator to reduce grain loss. As one example, the grain loss may be displayed on an operator interface display, along with user input mechanisms that can be actuated to see suggested operational changes that the operator can make to reduce grain loss. In that case, the operator can actuate the user input mechanism and view the suggested operational changes. This is but one example of how the corrected loss signal 260 can be surfaced for the operator and for operator interaction.

Corrected loss signal 260 can also be provided to control system 218 where it can be used to automatically control one or more of the various controlled systems 220 on machine 100 to reduce grain loss. The automation can take place without informing the operator, in conjunction with informing the operator, or after operator authorization is received or otherwise.

The corrected loss signal 260 can also be provided through communication component 216 to one or more remote systems 210. The remote systems 210 can display the grain loss, in near real time, for a person at the remote system 210, or the grain loss can store the corrected loss signal 260 for further analysis, for mapping, or for a wide variety of other reasons. Grain loss correction system 226 can output the corrected loss signal 260 to other components or systems 318 as well.

In one example, grain loss correction system 226 intermittently repeats the process of detecting context with components 228 and generating corrected loss signal 260. Grain loss correction system 226 can do so periodically, when triggered by changing context information, or based on other criteria. As one example, the context information indicates that when the operator starts harvesting with machine 100, the crop is relatively moist. However, later in the day, or later in the harvesting operation, it may be that the crop or material other than grain dries out. When such a contextual change is detected, system 226 can repeat the process of generating the corrected loss signal 260, based upon the new context information. Determining whether it is time to repeat the correction operation is indicated by block 320. If so, processing reverts to block 300. If not, then system 226 waits until either it is time to repeat the correction operation, or until the harvesting operation ends as indicated by block 322.

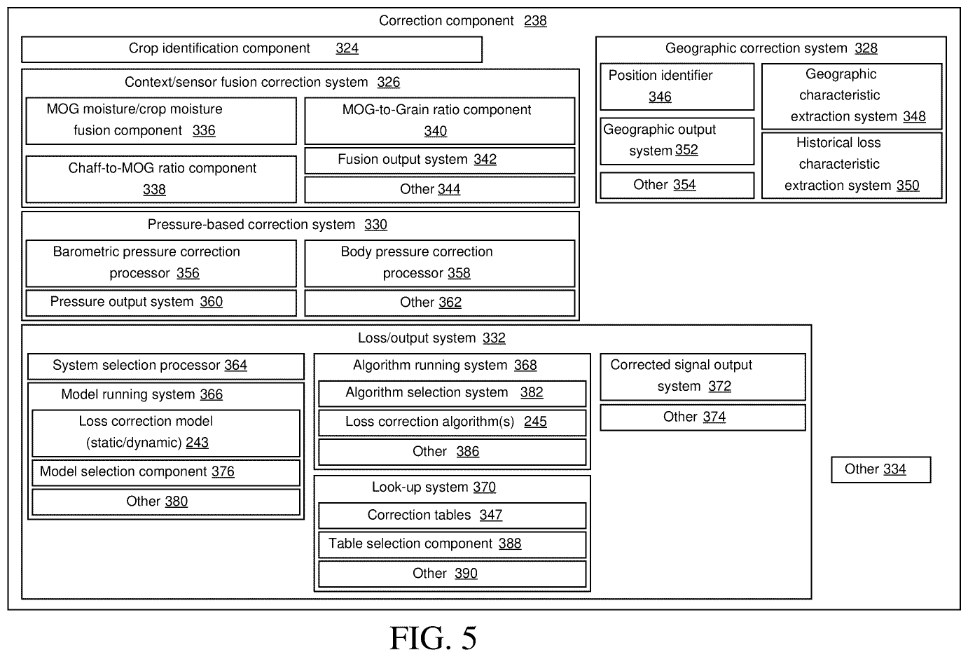

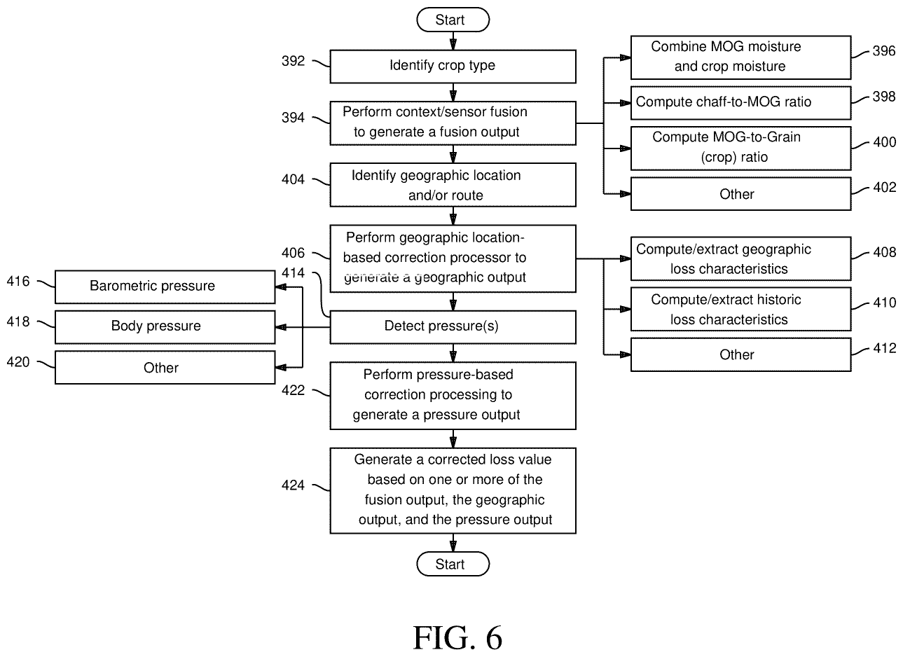

FIG. 5 is a block diagram showing one example of correction component 238 in more detail. In the example shown in FIG. 5, correction component 238 includes crop identification component 324, context/sensor fusion correction system 326, geographic correction system 328, pressure-based correction system 330, loss output system 332, and other items 334. Context/sensor fusion correction system 326 can include MOG moisture/crop moisture fusion component 336, chaff-to-MOG ratio component 338, MOG-to-grain ratio component 340, fusion output system 342, and other items 344. Geographic correction system 328 can include position identifier 346, geographic characteristic extraction system 348, historic loss characteristic extraction system 350, geographic output system 352, and other items 354. Pressure-based correction system 330 can include barometric pressure correction processor 356, body pressure correction processor 358, pressure output system 360, and other items 362. Loss output system 332 can include system selection processor 364, model running system 366, algorithm running system 368, lookup system 370, corrected signal output system 372, and other items 374. Model running system 366 can include model selection component 376, and model running logic that runs one or more loss correction models 243, and other items 380. Algorithm running system 368 can include algorithm selection system 382, algorithm running logic that runs one or more loss correction algorithms 245, and other items 386. Lookup system 370 can include table selection component 388, one or more correction tables 247, and other items 390.

Before describing the operation of correction component 238 in more detail, a discussion of some of the items in correction component 238 and their operation will first be provided. Crop identification component 324 identifies the type of crop being harvested by machine 100. Crop identification component 324 can identify the crop based upon an operator input from operator 206, or by accessing and “as-planted” map or table which identifies the type of crop planted in the field being harvested by machine 100. Crop identification component 324 can also be a sensor, such as an optical sensor or another sensor, that senses the crop being harvested. An optical sensor can capture an image of the crop and image processing functionality can process that image to identify the crop. Crop identification component 324 can identify the crop being harvested in other ways as well.

Context/sensor fusion correction system can fuse or combine different context information or sensor signals where the fused or combined signal values have some correlation to the error in the grain loss signals generated by grain loss sensors 230-232. Based on that correlation, a fusion output can be provided to loss output system 332 for use in generating corrected loss signal 260. MOG moisture/crop moisture fusion component 336 can combine or fuse sensor signals generated by MOG moisture sensor 168 and crop moisture sensor 170 to generate a fusion output. For instance, where there is a correlation between the MOG moisture and crop moisture and the error in the crop loss sensed by loss sensors 230-232, then that correlation can be captured in a fusion output which combines the outputs from the MOG moisture sensor 168 and crop moisture sensor 170. That fusion output can be output by fusion output system 342 to loss output system 332 which uses the fusion output to generate corrected loss signal 260. The fusion output can also be combined with other sensor signals from other sensors, or other context data, to generate another fusion output.

There may also be a correlation between the error in the loss sensor signal generated by loss sensors 230-232 and a ratio of the volume or other amount of chaff to the volume or other amount of MOG being processed by machine 100. It will be noted that while the present discussion uses volume as the amount being processed, the amount could just as easily be processed in other forms as well, such as mass, weight, mass flow, etc. and volume is used as one example. Therefore, chaff-to-MOG ratio component 338 receives an input from chaff volume sensor 164 and MOG volume sensor 166 and generates a ratio of the values indicated by those sensors. That ratio can be combined with any other sensor signals or other context data to generate a fusion output which is provided by fusion output system 342 to loss output system 332.

There may also be a correlation between the error in the sensor signals generated by grain loss sensors 230-232 and the ratio of the volume of MOG to the volume of grain being processed by machine 100. Thus, MOG-to-grain ratio component 340 may receive an output from MOG volume sensor 166 indicative of the volume of MOG being processed by machine 100 and a grain flow sensor or yield sensor 133 (or another sensor such as a signal from kernel weight sensor 171) indicative of the volume or weight or other measure of grain being processed by machine 100. MOG-to-grain ratio component 340 can generate a ratio of those two signal values and provide that ratio to fusion output system 342. That ratio can also be combined with other sensor signals from other sensors or other context data to generate the fusion output. Fusion output system 342 can provide the fusion output to loss output system 332 for use in generating corrected loss signal 260.

It will also be noted that any of a wide variety of other components 344 can fuse other combinations of context data and/or sensor data where the combination or fusion has a correlation to the error in the grain loss signals generated by grain loss sensors 230-232. Fusion output system 342 can generate an output indicative of that context or sensor fusion to loss output system 332 for use in generating corrected loss signal 260.

Geographic correction system 328 can identify the geographic location of machine 100 or the future location of machine 100, by detecting its heading and route and identify or extract geographic characteristics that may have a correlation to the error in the grain loss signals generated by grain loss sensors 230-232. Similarly, geographic correction system 328 can identify historical loss characteristics that have historically been observed or encountered at the geographic location of machine 100. Based upon the geographic characteristics and/or the historical loss characteristics, geographic correction system 328 can generate an output to loss output system 332 that can be used to generate corrected loss signal 260. Position identifier 346 thus identifies the geographic location or position of machine 100. Position identifier 346 may receive an input from geographic position sensor 145 and identify the location of machine 100 (or its future location) based upon the input from sensor 145. Geographic characteristic extraction system 348 then extracts geographic characteristics which may have a correlation to the error in the loss signal generated by grain loss sensors 230-232. For instance, once knowing the geographic location of machine 100, geographic characteristic extraction system 348 can access data store 235 to obtain geographic characteristics 237 that are correlated to the error in the signal generated by sensors 230-232. Such characteristics may be the elevation of the machine 100 at the detected location, the weather at that location, other environmental characteristics at that location, the type of soil at that location, the condition of the soil (whether it is dry, muddy, rocky, etc.) or other characteristics. Geographic characteristics 237 can be obtained from another machine as well, or from a map or other source. For example, a sprayer may have passed through the field and gathered geo-referenced data indicative of the presence of weeds or other plants. Geographic characteristic extraction system 348 can process those characteristics to generate an output to geographic output system 352. Geographic output system 352 can generate or provide a geographic output, which has a correlation to the error in the loss signal, to loss output system 332 which can use the geographic output in generating corrected loss signal 260.

Historical loss characteristic extraction system 350 can use the position of machine 100 provided by position identifier 346 and access historical loss characteristics 239 from data store 235 or elsewhere. The historic loss characteristics 239 may be indicative of, or correlated to, the error in the loss sensor signal generated by sensors 230-232 that has been encountered historically at the sensed location of machine 100. Historical loss characteristic extraction system 350 can generate an output based upon the historic loss characteristics 239. That historic loss output can be provided by geographic output system 352 instead of, or in combination with, the output from geographic characteristic extraction system 348, to loss output system 332 for use in generating the corrected loss signal 260.

Pressure-based correction system 330 identifies and processes pressure readings which may be correlated to the error in the loss sensor signals generated by loss sensors 230-232. For instance, barometric pressure correction processor 356 can receive an input from barometric pressure sensor 162 where the barometric pressure has a correlation to the loss sensor signal error. Body pressure correction processor 358 can receive a signal from body pressure sensor 160 indicative of the pressure inside the body of machine 100, where the body pressure has a correlation to the loss sensor signal error. Pressure output system 360 can generate a pressure output based upon inputs from the barometric pressure correction processor 356 and/or the body pressure correction processor 358. That pressure output can be provided to loss output system 332 for use in generating the corrected loss signal 260.

System selection processor 364 receives the outputs from one or more of systems 326, 328, and 330 and selects which error correction system 366, 368, 370 should be used to generate the corrected loss signal 260. Thus, system selection processor 364 may consider the selection criteria stored in knowledge base 236. System selection processor 364 may run a selection algorithm or a selection model or identify which of the systems 366, 368 and 370 should be used to correct the grain loss signals generated by loss sensors 230-232, given the context information and/or the inputs received from one or more of systems 326, 328, and 330. By way of example, in certain contexts it may be that a loss correction model 243 should be used while in other contexts a loss correction album algorithm 245 or correction table 247 should be used. Thus, based upon the outputs from systems 326, 328, and/or 330, and/or based upon context information, system selection processor 364 selects one of the systems 366, 368, and 370 to generate the corrected loss signal 260.

If processor 364 selects model running system 366, model selection component 376 selects one or more of the loss correction models 243 that should be run to generate the corrected loss signal 260, based upon context information or based upon other inputs. Thus, model selection component 376 may, itself, be a selection model or selection algorithm or another mechanism for deciding which loss correction model 243 should be run to generate the corrected loss signal 260. The selection criteria upon which model selection component 376 makes its selection may include context information or other information.

Assuming that model running system 366 is selected by system selection processor 364, and assuming a particular loss correction model 243 is selected by model selection component 376, then model running system 366 runs the selected loss correction model 243, based upon an input of context information and/or inputs from one or more of the systems 326, 328, and 330. The output of the selected loss correction model 243 is provided to corrected signal output system 372 which outputs the corrected loss signal to 260.

If algorithm running system 368 is selected by system selection processor 364, then algorithm selection system 382 selects one of a plurality of different loss correction algorithms 245 that may be run given the current context or given the inputs from systems 326, 328, and/or 330. Algorithm running system 368 then runs the selected loss correction algorithm 245 to correct the sensor signals output by grain loss sensors 230-232. Loss correction algorithm 245 provides an output to corrected signal output system 372 which generates or outputs the corrected loss signal 260.

If system selection processor 364 selects lookup system 370, then table selection component 388 selects one of a plurality of different correction tables 247. Lookup system 370 looks up correction values in the selected correction table 247 based upon context information or based upon outputs from systems 326, 328, and/or 330. Those correction values can be output to corrected signal output system 372 which outputs corrected loss signal 260.

FIG. 6 is a flow diagram illustrating one example of the operation of correction component 238 in detecting or obtaining context information and generating the corrected loss signal 260. It is first assumed that crop identification component 324 identifies the type of the crop being harvested by machine 100. Identifying crop type is indicated by block 392 in the flow diagram of FIG. 6. Context/sensor fusion correction system 326 can perform context/sensor fusion processing to generate a fusion output, as indicated by block 394. For instance, MOG moisture/crop moisture fusion component 336 can combine MOG moisture and crop moisture values, as indicated by block 396. Chaff-to-MOG ratio component 338 can generate a chaff-to-MOG ratio, as indicated by block 398. MOG-to-grain ratio component 340 can compute a MOG-to-grain ratio 400. Any of a variety of other processing functionality 344 can generate outputs indicative of other sensor or context fusion or combinations as indicated by block 402.

Position identifier 346 identifies the geographic location, heading, and/or route of machine 100, as indicated by block 404. Geographic correction system 328 then performs geographic location-based correction processing to generate a geographic output, as indicated by block 406. Based upon the identified geographic position or location of machine 100, geographic characteristic extraction system 348 extracts or computes geographic loss characteristics that may be used by loss output system 332. Computing or extracting geographic loss characteristics is indicated by block 408 in the flow diagram of FIG. 6. Historic loss characteristic extraction system 350 also computes or extracts historic loss characteristics as indicated by block 410. The geographic and/or historic loss characteristics can be used by geographic output system 352 to generate a geographic output. Other components can be used to identify geographic characteristics and/or historic loss characteristics as indicated by block 412.

Pressure-based correction system 330 then detects pressures that can be correlated to the error in the grain loss signal generated by sensors 230-232. Detecting pressures is indicated by block 414 in the flow diagram of FIG. 6. Barometric pressure correction processor 356 receives an input from barometric pressure sensor 162 indicative of the barometric pressure, as indicated by block 416. Body pressure correction processor 358 can receive an input from body pressure sensor 160 indicative of the pressure inside the body of machine 100, as indicated by block 418. Other pressures can be detected and provided to pressure-based correction system 330 as well, as indicated by block 420.

Pressure-based correction system 330 then performs pressure-based correction processing, based upon the detected pressures, to generate a pressure output, as indicated by block 422. The pressure output may be correlated to the error in the grain loss signal generated by grain loss sensors 230-232, and the pressure output may be provided to loss output system 332.

Loss output system 332 then generates a corrected loss value or corrected loss signal 260 based on one or more of the fusion output from system 326, the geographic output from system 328, the pressure output from system 330, and/or other context information. Generating a corrected loss value or corrected loss signal 260 is indicated by block 424 in the flow diagram of FIG. 6.

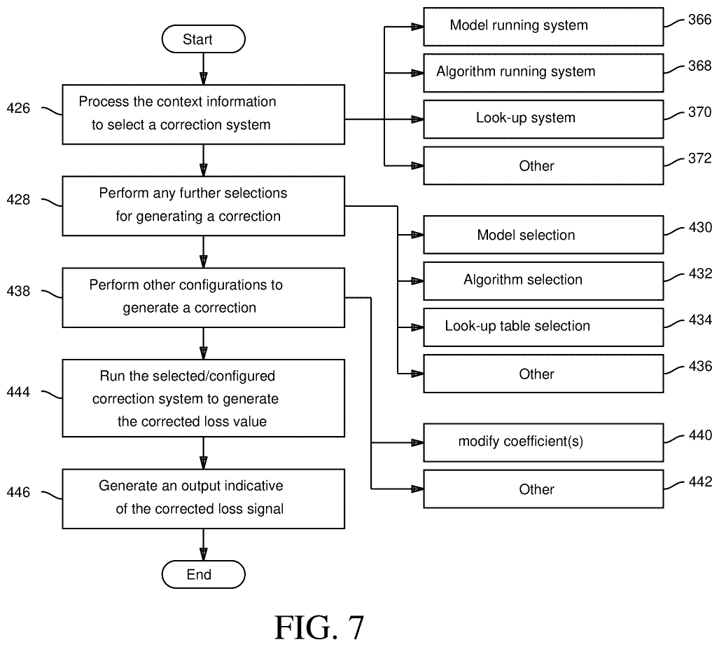

FIG. 7 is a flow diagram illustrating one example of the operation of loss output system 332 in more detail. It is first assumed that system selection processor 364 processes any context information in the outputs from systems 326, 328, and/or 330 to select a correction system for use in generating corrected loss signal 260. Processing the information to select a correction system is indicated by block 426 in the flow diagram of FIG. 7. The selected correction system can be model running system 366, algorithm running system 368, lookup system 370, or any variety of other correction systems 372.

Once the correction system is selected, then that correction system may make any further selections for generating the corrected loss signal 260. Performing any further selections is indicated by block 428 in the flow diagram of FIG. 7. For instance, model selection component 376 can perform model selection to select a loss correction model 243, as indicated by block 430. Algorithm selection system 382 can select a loss correction algorithm 245, as indicated by block 432. Table selection component 388 can select a lookup table 247, as indicated by block 434, and other selection systems can perform other selections as well, as indicated by block 436.

The selected correction system can perform other configurations or modifications to generate a correction as well, as indicated by block 438. For instance, algorithm running system 368 may configure the selected loss correction algorithm 245 with modified coefficients or other values, as indicated by block 440. The selected correction system can be configured in other ways as well, as indicated by block 442.

Loss output system 332 then runs the selected and configured correction system to generate the corrected loss value, or corrected loss signal 260, as indicated by block 444. Corrected signal output system 372 then outputs the corrected loss signal 260 as indicated by block 446.

It can thus be seen that the present description describes a system that can use geographic information, historical information, or any of a wide variety of combinations of context information, that is used to correct a grain loss sensor signal. The present description also describes a system that can use geographic information, historical information, and/or different combinations of sensor information as input to a loss correction model, to a loss correction algorithm, or to select a value from a lookup table. Thus, the present description describes a system that greatly enhances the accuracy of the loss signal generated in a harvester, and that accounts for a wide variety of different contexts and combinations of context information, that are correlated to the accuracy of the grain loss sensors.

The present discussion has mentioned processors and servers. In one example, the processors and servers include computer processors with associated memory and timing circuitry, not separately shown. The processors or servers are functional parts of the systems or devices to which they belong and are activated by and facilitate the functionality of the other components or items in those systems.

Also, a number of user interface (UI) displays have been discussed. The UI displays can take a wide variety of different forms and can have a wide variety of different user actuatable input mechanisms disposed thereon. For instance, the user actuatable input mechanisms can be text boxes, check boxes, icons, links, drop-down menus, search boxes, etc. The mechanisms can also be actuated in a wide variety of different ways. For instance, the mechanisms can be actuated using a point and click device (such as a track ball or mouse). The mechanisms can be actuated using hardware buttons, switches, a joystick or keyboard, thumb switches or thumb pads, etc. The mechanisms can also be actuated using a virtual keyboard or other virtual actuators. In addition, where the screen on which the mechanisms are displayed is a touch sensitive screen, the mechanisms can be actuated using touch gestures. Also, where the device that displays the mechanisms has speech recognition components, the mechanisms can be actuated using speech commands.

A number of data stores have also been discussed. It will be noted the data stores can each be broken into multiple data stores. All can be local to the systems accessing the data stores, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with functionality distributed among more components.

It will be noted that the above discussion has described a variety of different systems, components, generators, models, sensors, algorithms, identifiers, and/or logic. It will be appreciated that such systems, components, generators, models, sensors, algorithms, identifiers, and/or logic can be comprised of hardware items (such as processors and associated memory, or other processing components, some of which are described below) that perform the functions associated with those systems, components, generators, models, sensors, algorithms, identifiers, and/or logic. In addition, the systems, components, generators, models, sensors, algorithms, identifiers, and/or logic can be comprised of software that is loaded into a memory and is subsequently executed by a processor or server, or another computing component, as described below. The systems, components, generators, models, sensors, algorithms, identifiers, and/or logic can also be comprised of different combinations of hardware, software, firmware, etc., some examples of which are described below. These are only some examples of different structures that can be used to form the systems, components, generators, models, sensors, algorithms, identifiers, and/or logic described above. Other structures can be used as well.

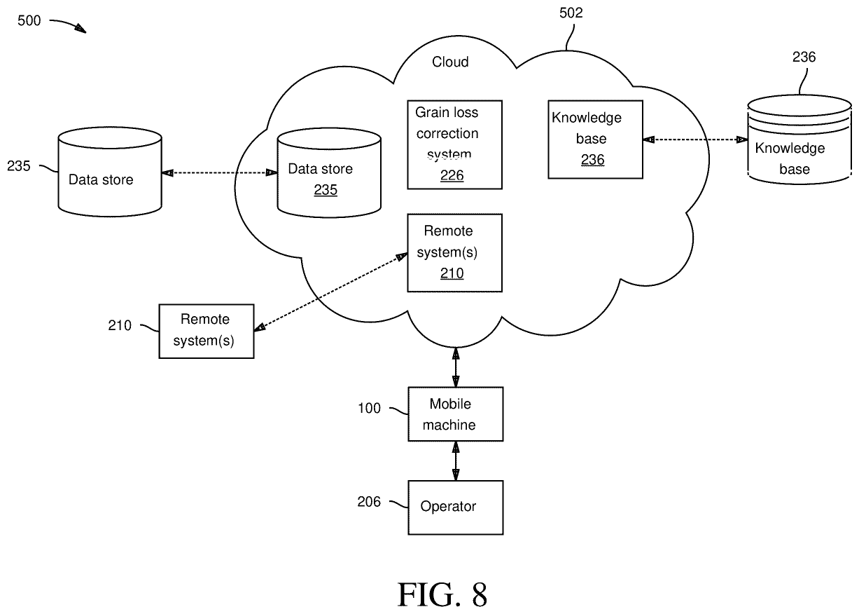

FIG. 8 is a block diagram of agricultural system 200, shown in FIG. 2, except that it communicates with elements in a remote server architecture 500. In an example, remote server architecture 500 can provide computation, software, data access, and storage services that do not require end-user knowledge of the physical location or configuration of the system that delivers the services. In various examples, remote servers can deliver services over a wide area network, such as the internet, using appropriate protocols. For instance, remote servers can deliver applications over a wide area network, and they can be accessed through a web browser or any other computing component. Software or components shown in previous FIGS. as well as the corresponding data, can be stored on servers at a remote location. The computing resources in a remote server environment can be consolidated at a remote data center location or they can be dispersed. Remote server infrastructures can deliver services through shared data centers, even though they appear as a single point of access for the user. Thus, the components and functions described herein can be provided from a remote server at a remote location using a remote server architecture. Alternatively, the components and functions can be provided from a conventional server, or they can be installed on client devices directly, or in other ways.

In the example shown in FIG. 8, some items are similar to those shown in previous FIGS. and they are similarly numbered. FIG. 8 specifically shows that portions of grain loss correction system 226, and data store 235, and/or other systems 210 can be located at a remote server location 502. Therefore, mobile agricultural machine 100 accesses those systems through remote server location 502.

FIG. 8 also depicts another example of a remote server architecture. FIG. 8 shows that it is also contemplated that some elements of previous FIGS are disposed at remote server location 502 while others are not. By way of example, data store 235, parts of speed control system grain loss correction system 226, and/or other items can be disposed at a location separate from location 502 and accessed through the remote server at location 502. Regardless of where the items are located, the items can be accessed directly by mobile agricultural machine 100, through a network (either a wide area network or a local area network), the items can be hosted at a remote site by a service, or the items can be provided as a service, or accessed by a connection service that resides in a remote location. Also, the data can be stored in substantially any location and intermittently accessed by, or forwarded to, interested parties. All of these architectures are contemplated herein.

It will also be noted that the elements of previous FIGS., or portions of them, can be disposed on a wide variety of different devices. Some of those devices include servers, desktop computers, laptop computers, tablet computers, or other mobile devices, such as palm top computers, cell phones, smart phones, multimedia players, personal digital assistants, etc.

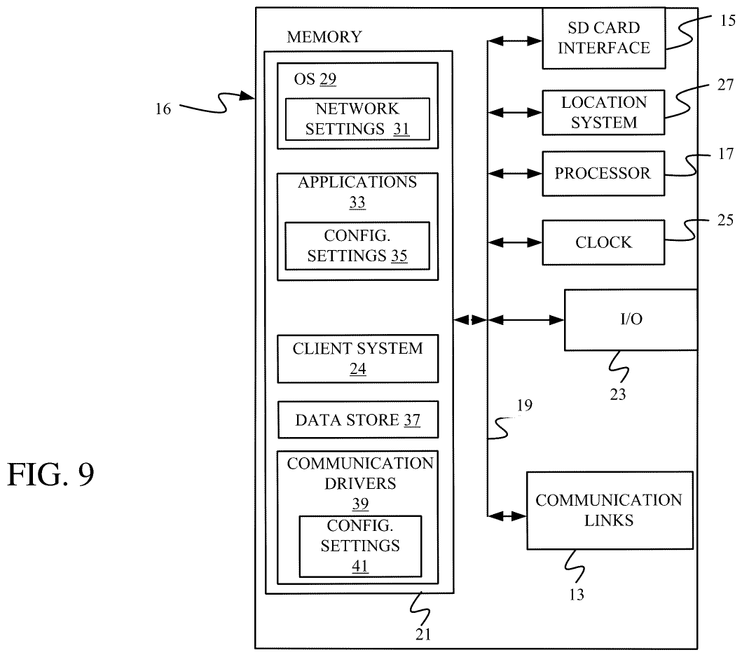

FIG. 9 is a simplified block diagram of one illustrative example of a handheld or mobile computing device that can be used as a user's or client's handheld device 16, in which the present system (or parts of it) can be deployed. For instance, a mobile device can be deployed in the operator compartment of mobile agricultural machine 100 for use in generating, processing, or displaying the grain loss data. FIGS. 9-11 are examples of handheld or mobile devices.

FIG. 9 provides a general block diagram of the components of a client device 16 that can run some components shown in previous FIGS., that interact with them, or both. In device 16, a communications link 13 is provided that allows the handheld device to communicate with other computing devices and under some examples provides a channel for receiving information automatically, such as by scanning. Examples of communications link 13 include allowing communication though one or more communication protocols, such as wireless services used to provide cellular access to a network, as well as protocols that provide local wireless connections to networks.

In other examples, applications can be received on a removable Secure Digital (SD) card that is connected to an interface 15. Interface 15 and communication links 13 communicate with a processor 17 (which can also embody processors or servers from previous FIGS.) along a bus 19 that is also connected to memory 21 and input/output (I/O) components 23, as well as clock 25 and location system 27.

I/O components 23, in one example, are provided to facilitate input and output operations. I/O components 23 for various examples of the device 16 can include input components such as buttons, touch sensors, optical sensors, microphones, touch screens, proximity sensors, accelerometers, orientation sensors and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a dead reckoning system, a cellular triangulation system, or other positioning system. Location system 27 can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. Memory 21 can also include computer storage media (described below). Memory 21 stores computer readable instructions that, when executed by processor 17, cause the processor to perform computer-implemented steps or functions according to the instructions. Processor 17 can be activated by other components to facilitate their functionality as well.

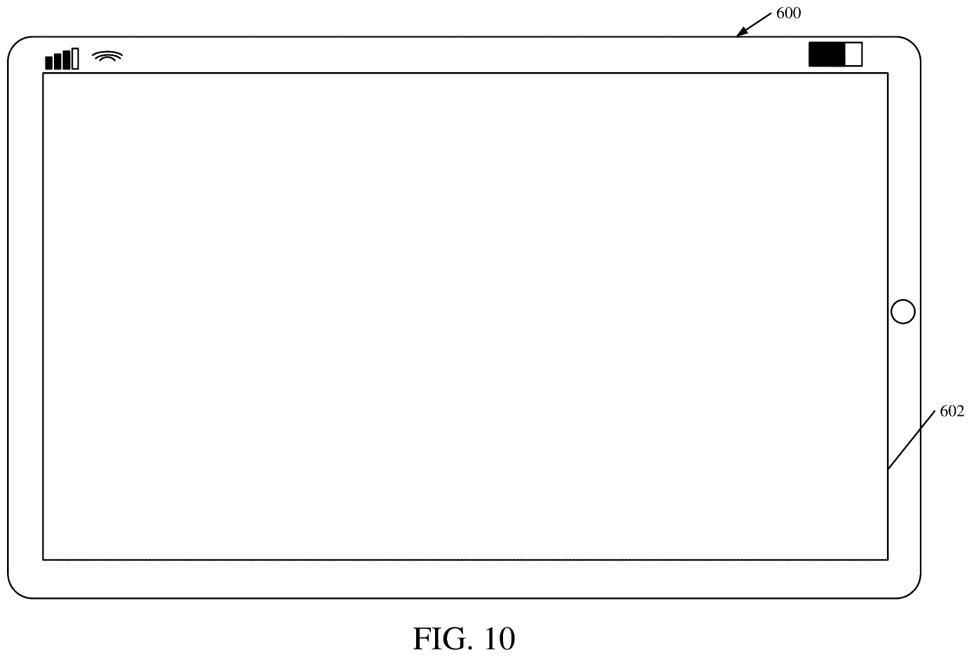

FIG. 10 shows one example in which device 16 is a tablet computer 600. In FIG. 10, computer 600 is shown with user interface display screen 602. Screen 602 can be a touch screen or a pen-enabled interface that receives inputs from a pen or stylus. Computer 600 can also use an on-screen virtual keyboard. Of course, computer 600 might also be attached to a keyboard or other user input device through a suitable attachment mechanism, such as a wireless link or USB port, for instance. Computer 600 can also illustratively receive voice input as well.

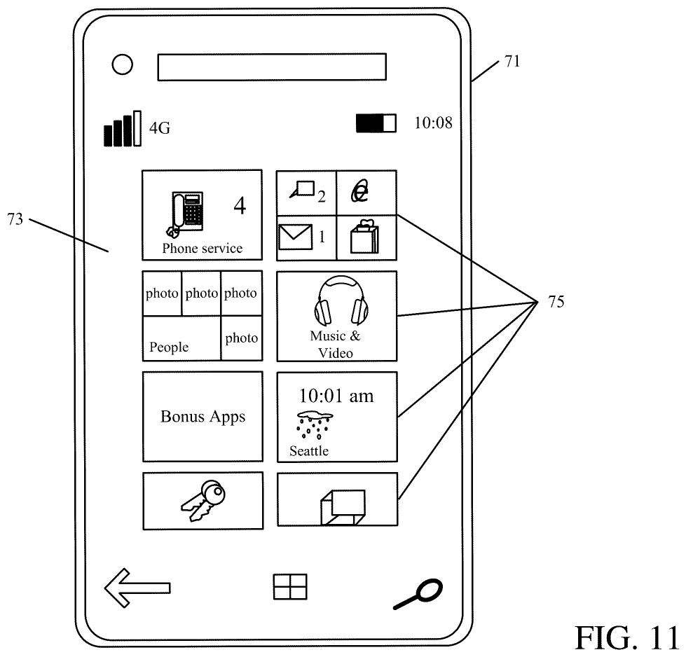

FIG. 11 shows that the device can be a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

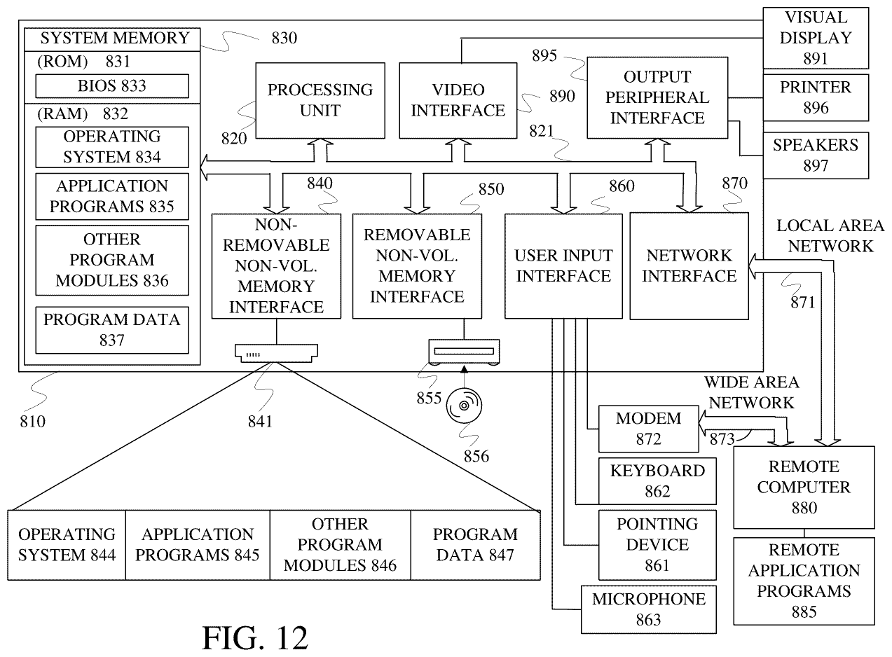

FIG. 12 is one example of a computing environment in which elements of previous FIGS., or parts of it, (for example) can be deployed. With reference to FIG. 12, an example system for implementing some embodiments includes a computing device in the form of a computer 810 programmed to operate as described above. Components of computer 810 may include, but are not limited to, a processing unit 820 (which can comprise processors or servers from previous FIGS.), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. Memory and programs described with respect to previous FIGS. can be deployed in corresponding portions of FIG. 12.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from and does not include a modulated data signal or carrier wave. Computer storage media includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information, and which can be accessed by computer 810. Communication media may embody computer readable instructions, data structures, program modules or other data in a transport mechanism and includes any information delivery media. The term “modulated data signal” means a signal that has one or more of its characteristics set or changed in such a manner as to encode information in the signal.

System memory 830 includes computer storage media in the form of volatile and/or nonvolatile memory such as read only memory (ROM) 831 and random-access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 12 illustrates operating system 834, application programs 835, other program modules 836, and program data 837.

The computer 810 may also include other removable/non-removable volatile/nonvolatile computer storage media. By way of example only, FIG. 12 illustrates a hard disk drive 841 that reads from or writes to non-removable, nonvolatile magnetic media, an optical disk drive 855, and nonvolatile optical disk 856. The hard disk drive 841 is typically connected to the system bus 821 through a non-removable memory interface such as interface 840, and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (e.g., ASICs), Application-specific Standard Products (e.g., ASSPs), System-on-a-chip systems (SOCs), Complex Programmable Logic Devices (CPLDs), etc.

The drives and their associated computer storage media discussed above and illustrated in FIG. 12, provide storage of computer readable instructions, data structures, program modules and other data for computer 810. In FIG. 12, for example, hard disk drive 841 is illustrated as storing operating system 844, application programs 845, other program modules 846, and program data 847. Note that these components can either be the same as or different from operating system 834, application programs 835, other program modules 836, and program data 837.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus but may be connected by other interface and bus structures. A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections (such as a controller area network-CAN, local area network-LAN, or wide area network WAN) to one or more remote computers, such as a remote computer 880.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. In a networked environment, program modules may be stored in a remote memory storage device. FIG. 12 illustrates, for example, that remote application programs 885 can reside on remote computer 880.

It should also be noted that the different examples described herein can be combined in different ways. That is, parts of one or more examples can be combined with parts of one or more other examples. All of this is contemplated herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer implemented method, comprising:
generating a loss signal indicative of sensed crop loss sensed during a harvesting operation performed by a harvester;
detecting a location corresponding to the harvester;
generating a geographic context signal, indicative of geographic context, based on the detected location; and
generating a corrected loss signal based on the loss signal and the geographic context signal.

2. The computer implement ted method of claim 1 wherein generating a geographic context signal comprises:
obtaining a set of geographic loss characteristics correlated to an error in the loss signal; and
generating the geographic context signal based on the set of geographic loss characteristics.

3. The computer implemented method of claim 2 and further comprising:
obtaining a set of historic loss characteristics corresponding to the detected location, the set of historic loss characteristics being correlated to an error in the loss signal. ; and
generating the geographic context signal based on the set of historic loss characteristics.

4. The computer implemented method of claim 1 wherein detecting a location comprises:
identifying a heading of the harvester; and
identifying a route of the harvester.

5. The computer implemented method of claim 1 wherein generating a corrected loss signal comprises:
selecting a correction system, of a plurality of correction systems, based on the geographic context signal; and
generating the corrected loss signal with the selected correction system.

6. The computer implemented method of claim 5 wherein selecting a correction system comprises:
selecting, as a selected correction system, one of a model running system, an algorithm running system, and a look-up system.

7. The computer implemented method of claim 1 wherein generating the corrected loss signal comprises:
selecting a corrective component, of a plurality of corrective components in a correction system, based on the geographic context signal; and
generating the corrected loss signal with the selected corrective component.

8. The computer implemented method of claim 7 wherein the correction system comprises a model running system and wherein selecting a corrective component comprises:
selecting a loss correction model, from a plurality of different loss correction models.

9. The computer implemented method of claim 7 wherein the correction system comprises an algorithm running system and wherein selecting a corrective component comprises:
selecting a loss correction algorithm, from a plurality of different loss correction algorithms.

10. The computer implemented method of claim 7 wherein the correction system comprises a look-up system and wherein selecting a corrective component comprises:
selecting a loss correction look-up table, from a plurality of different loss correction look-up tables.

11. The computer implemented method of claim 1 wherein generating a geographic context signal comprises:
identifying a context element as at least one of an elevation, an environmental characteristic, a crop characteristic, a terrain characteristic, or a soil characteristic based on the detected location; and
generating the geographic context signal based on the identified context element.

12. An agricultural system, comprising:
a crop loss sensor configured to generate a loss signal indicative of sensed crop loss sensed during a harvesting operation performed by a harvester;
a geographic position sensor configured to detect a location corresponding to the harvester;
a geographic correction system configured to generate a geographic output signal, indicative of geographic context, based on the detected location; and
a loss output system configured to generate a corrected loss signal based on the loss signal and the geographic output signal.

13. The agricultural system of claim 12 wherein the geographic correction system comprises:
a geographic characteristic extraction system configured to obtain a set of geographic loss characteristics correlated to an error in the loss signal; and
a geographic output system configured to generate the geographic output signal based on the set of geographic loss characteristics.

14. The agricultural system of claim 12 and further comprising:
a historic loss characteristic extraction system configured to obtain a set of historic loss characteristics corresponding to the detected location, the set of historic loss characteristics being correlated to an error in the loss signal, wherein the geographic output system is configured to generate the geographic output signal based on the set of historic loss characteristics.

15. The agricultural system of claim 12 wherein the loss output system comprises:
a plurality of different correction systems;
a system selection processor configured to selecting a correction system, of the plurality of different correction systems, based on the geographic output signal; and
a corrected signal output system configured to generate the corrected loss signal with the selected correction system.

16. The agricultural system of claim 15 wherein the plurality of different correction systems comprises:
a model running system;
an algorithm running system; and
a look-up system.

17. The agricultural system of claim 12 wherein the loss output system comprises:
a correction system having a plurality of different corrective components; and
a selection component configured to select a corrective component, of the plurality of different corrective components, based on the geographic output signal; and
a corrected signal output system configured to generate the corrected loss signal with the selected corrective component.

18. The agricultural system of claim 12 wherein the geographic correction system comprises:
a characteristic extraction system configured to identifying a context element as at least one of an elevation, an environmental characteristic, a crop characteristic, a terrain characteristic, or a soil characteristic based on the detected location; and
a geographic output system configured to generate the geographic output signal based on the identified context element.

19. A correction system, comprising:
at least one processor;
a data store storing computer executable instructions which, when executed by the at least one processor, causes the at least one processor to perform steps, comprising:
receiving a loss signal indicative of sensed crop loss sensed during a harvesting operation performed by a harvester;
receiving a location signal indicative of a geographic location corresponding to the harvester;
generating a geographic context signal, indicative of geographic context, based on the detected location; and
generating a corrected loss signal based on the loss signal and the geographic context signal.

20. The correction system of claim 19 wherein generating a geographic context signal comprises:
obtaining a set of historic loss characteristics corresponding to the geographic location, the set of historic loss characteristics being correlated to an error in the loss signal. ; and
generating the geographic context signal based on the set of historic loss characteristics.
